(19) United States
(12) Patent Application Publication
(10) Pub. No.: US 2003/0156697 A1
(43) Pub. Date: Aug. 21, 2003

(54) System and method to establish an on-demand expanded conference call for participants in an active two-party or three-way call

(76) Inventor: John C. Svercek, Apollo Beach, FL (US)

Correspondence Address: MASON & ASSOCIATES, PA, 17757 US HWY 19 N., SUITE 500, CLEARWATER, FL, 33764, US

(21) Appl. No.: 10/077,331

(22) Filed: Feb. 15, 2002

(51) Int. Cl. H04M 3/42

(52) U.S. Cl. 379/202.01; 379/207.02

(57) ABSTRACT

An on-demand teleconferencing system and method for an Expanded Conference Call (ECC) initiated by dialing an ECC Access Code when originating a new call to a Conference System, or causes an active two party or three-way call to be connected to a Conference System to allow a greater number of parties to participate in the conference call. A subscribing party initiates ECC by dialing an abbreviated ECC Access Code consisting of a dialing sequence of less than seven digits. The original two or three-way call participants in an active call are automatically connected to the conference system after the subscribing party initiates ECC without having to disconnect and originate new calls.

The invention relates to an on-demand teleconferencing system and method for an Expanded Conference Call (ECC) initiated by dialing an ECC Access Code when originating a new call to a Conference System, or causes an active two party or three-way call to be connected to a Conference System to allow a greater number of parties to participate in the conference call. A subscribing party initiates ECC by dialing an abbreviated ECC Access Code consisting of a dialing sequence of less than seven digits. The original two or three-way call participants in an active call are automatically connected to the conference system after the subscribing party initiates ECC without having to disconnect and originate new calls.

Business callers in their normal course of doing business establish voice communications with other parties. On occasion, during established calls, it becomes necessary to consult with or include additional parties on the call. The inclusion of three or more parties on a single call is known as a conference call. The normal method to add a third party to an established call is to utilize a feature called “Three-Way” calling. Three-Way calling is a common telecommunications capability available on Public Switched Telecommunications Network (PSTN) end office switches, Private Automatic Branch Exchanges (PABXs), or Hybrid PABX/Key Systems.

If however after adding a third party to the call via the Three-Way calling feature it becomes necessary to expand the conference call to include additional parties (four or more parties), current telecommunications methods and procedures requires that all parties on the existing three-way call disconnect and reestablish new calls to a Conference System. The current procedure requires that the conference call be deferred to a later time and or date when a Conference System is scheduled and conference call participants are notified of the call.

The current procedure is disruptive and unproductive. If more than three parties could be added to an established call, business decisions and productivity would be improved.

If a caller desires to establish a conference call, the caller must dial a PSTN telephone number which could also include special NPA code numbers such as Toll Free 800, 888, 877, etc. Conference numbers can vary from conference call to conference call. Conference subscribers must carefully track these numbers and distribute to conference participants as required.

The present invention allows a simple to remember ECC Access Code number to be dialed to initiate an on-demand conference session with a Conference System.

The present invention also solves the above inefficient operation by connecting existing call participants to a conference bridge without having to disconnect and initiate a new call to the Conference System. Once existing call participants are connected to the conference system, other participants can be added to the call immediately.

In summary, the invention is a system and its corresponding associated method of use as generally described as follows:

The system is for a subscriber to establish an on-demand conference call in a telecommunications network including a plurality of switching systems, one or more of which having one or more conference bridges, and comprises:

means for dialing and assigning an ECC Access Code which is common for all ECC subscribers served by a plurality of switches; and the ECC Access Code being conference call initiation means comprising a dialing sequence of less than seven digits.

The dialing sequence includes any one of a Vertical Service Code format consisting of *XX where X is any digit 0 to 9, an abbreviated dialing sequence of *XXX, *XXXX, *XXXXX, or *XXXXXX where X is any digit 0 to 9, an abbreviated dialing sequence of #XX, #XXX, #XXXX, #XXXXX, or #XXXXXX where X is any digit 0 to 9, an abbreviated dialing sequence of XX*, XXX*, XXXX*, XXXXX*, or XXXXXX* where X is any digit 0 to 9, and an abbreviated dialing sequence of XX#, XXX#, XXXX#, XXXXX#, or XXXXXX# where X is any digit 0 to 9.

The system further comprises means for initiating the on-demand conference call by going Off-Hook and dialing the ECC Access Code, wherein the subscriber initiating the on-demand conference call is not connected to a party participant.

The system also comprises means for connecting active call participants in an established two party or three-way call to a conference system without having to disconnect the active parties; means for the subscriber to initiate the ECC activation sequence by one of a Hook Flash followed by dialing via Dual Tone Multi-Frequency (DTMF) the ECC Access Code, via dialing the ECC Access Code via DTMF without the Hook-Flash, and via alternative input method such as key board entry without DTMF or dial pad without DTMF; means for a serving switch to recognize the ECC Access Code and to execute steps to transfer the active call participants to the conference system, the serving switch comprising one of a circuit switched Class 5 PTSN end office, a circuit switched Class 5 PTSN SSP end office, a circuit switched PABX, a HYBRID circuit switched PABX/Key system, a circuit switched Mobile Switching Office (MSO), a packet switched Class 5 end office or equivalent controlled by “Softswitch” technologies, a packet switched PABX or Hybrid PABX/Key System controlled by “Softswitch” technologies, or a packet switched MSO controlled by “Softswitch” technologies; and means for the serving switch to route the established call participants to the conference system based upon destination information provided by an ECC application.

The ECC application for the initiation of a new conference call or an established two party or three-way call to a Conference System is performed through one of internally in a serving switch embedded operations program and externally to the serving switch.

Communications between the serving switch and the external ECC application can utilize communications procedures supported by serving switching technology comprising one of Advanced Intelligent Network (AIN) Service Control Point (SCP) to Service Switching Point (SSP) procedures, Computer Telephony Interfaces (CTI), Switch to Computer Applications Interface (SCAI), Parlay, Java APIs for Integrated Networks (JAIN), and other defined switch to external interfaces.

In addition, the system comprises means for identifying the subscriber; and means for maintaining an account record and profile related to the subscriber, including Conference System routing information, wherein upon identification of the subscriber, the system accesses the subscriber's account record and profile to obtain the Conference System routing information.

The system further comprises means for enabling communication procedures including Advanced Intelligent Network (AIN) Originating triggers, call processing procedures and CTI call initiation procedures during the initiation of the established two party and three-way calls.

Also included are means for the ECC application to initiate additional information requests to the serving switch; and means for the ECC application to return call routing instructions to the serving switch to connect the existing parties to the Conference System.

Communications between the serving switch and an external computing platform containing the ECC application can utilize a plurality of Open Systems Interconnection (OSI) layer 1-3 technologies, including SS7, digital data circuit, analog modem, Internet Protocol (IP) and LAN/WAN.

In the accompanying drawings:

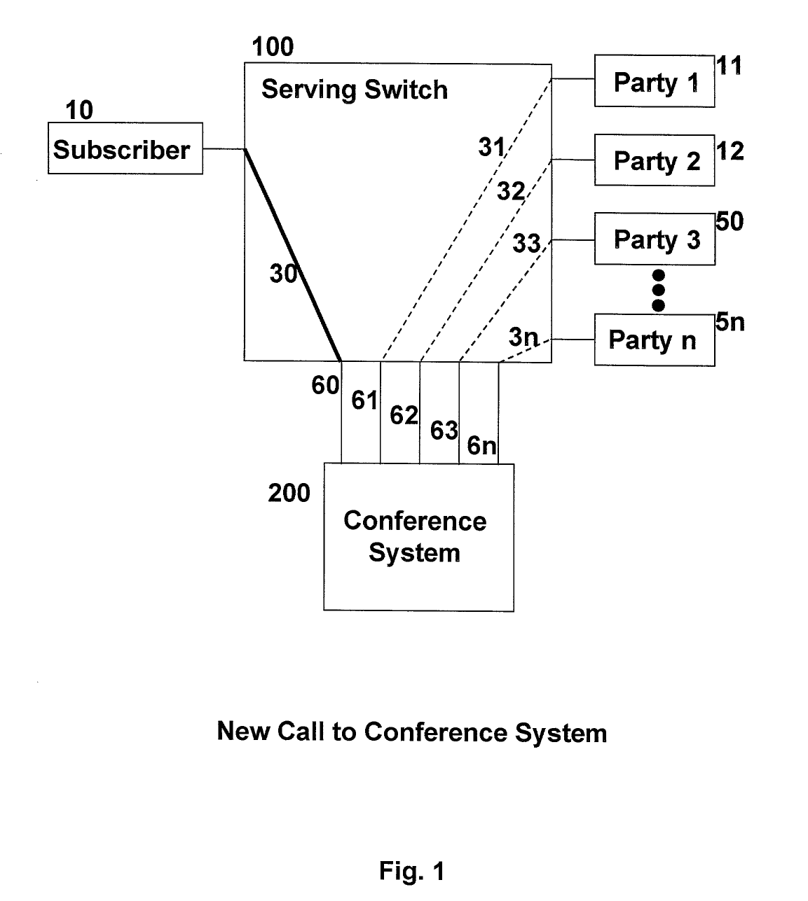

FIG. 1 schematically depicts a subscriber initiating a new call to a Conference System by dialing an ECC Access Code;

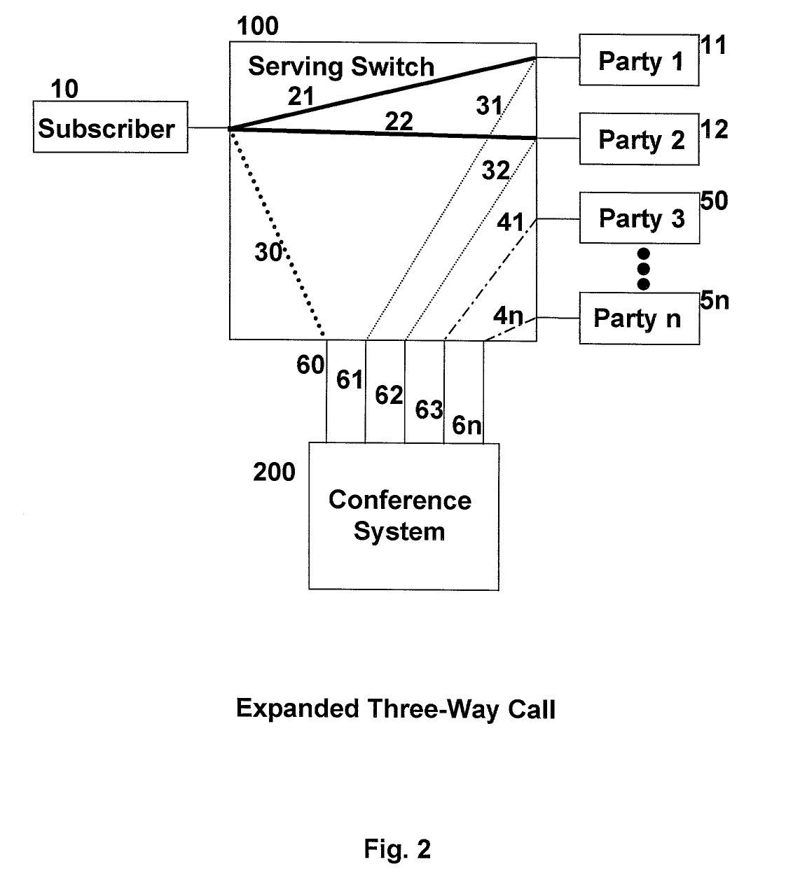

FIG. 2 schematically depicts the physical switch connections described by this invention for existing participants of an active two party or Three-Way call;

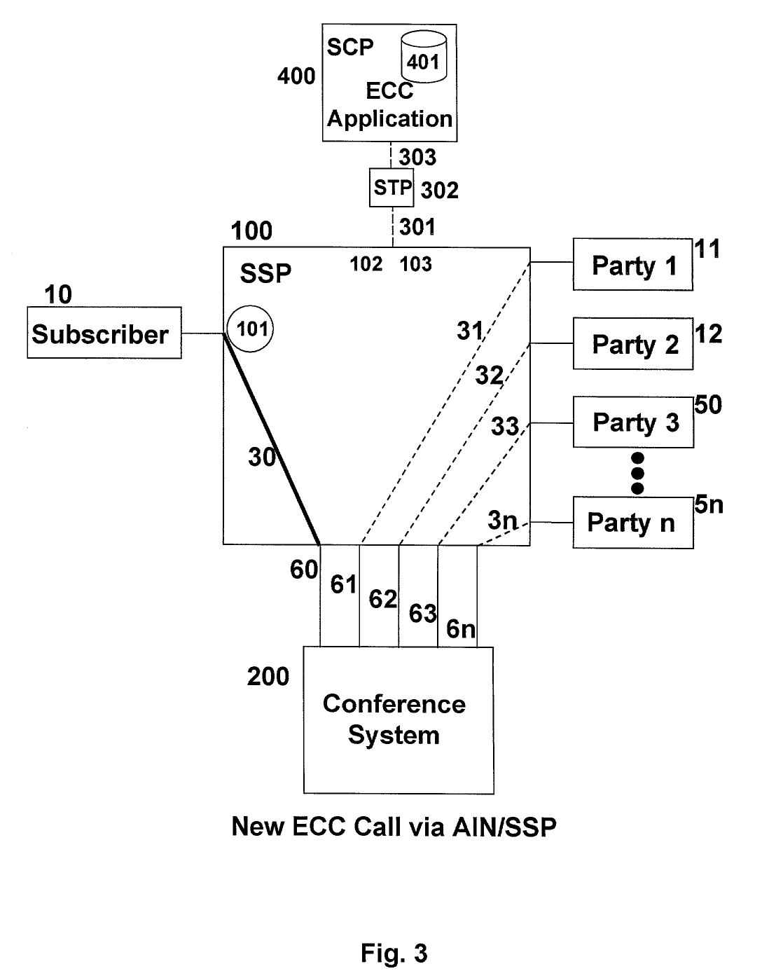

FIG. 3 schematically depicts the initiation of a new call via the ECC system via the Advanced Intelligent Network (AIN) architecture and a PSTN Service Switching Point (SSP) end office by simply dialing an ECC Access Code;

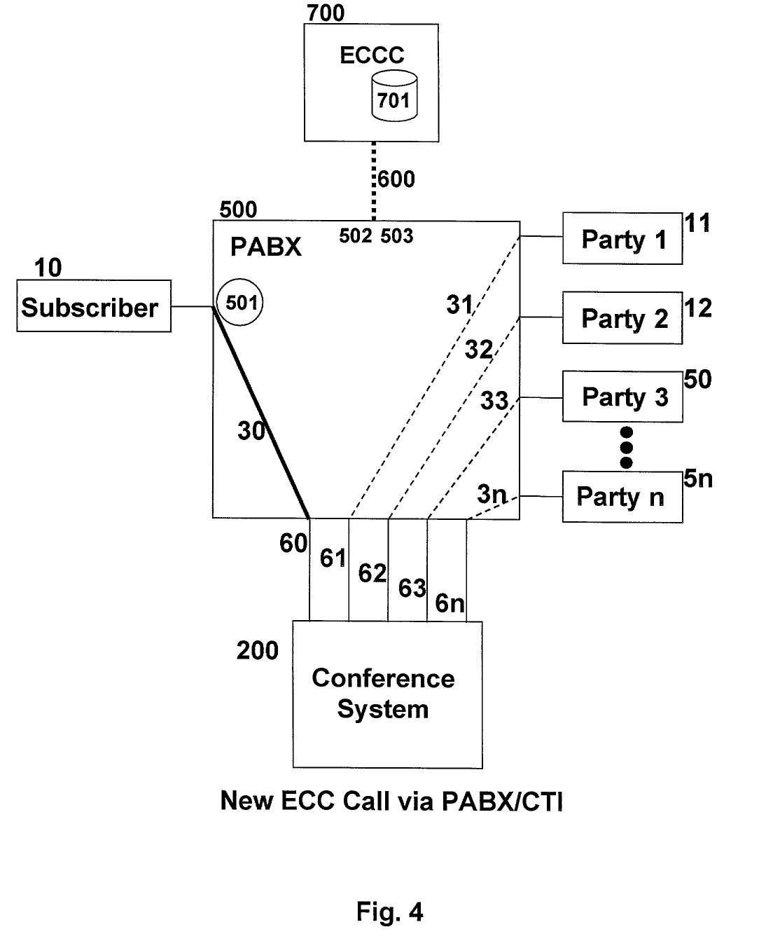

FIG. 4 schematically depicts the initiation of a new call via the ECC system for a PABX subscriber dialing the ECC Access Code;

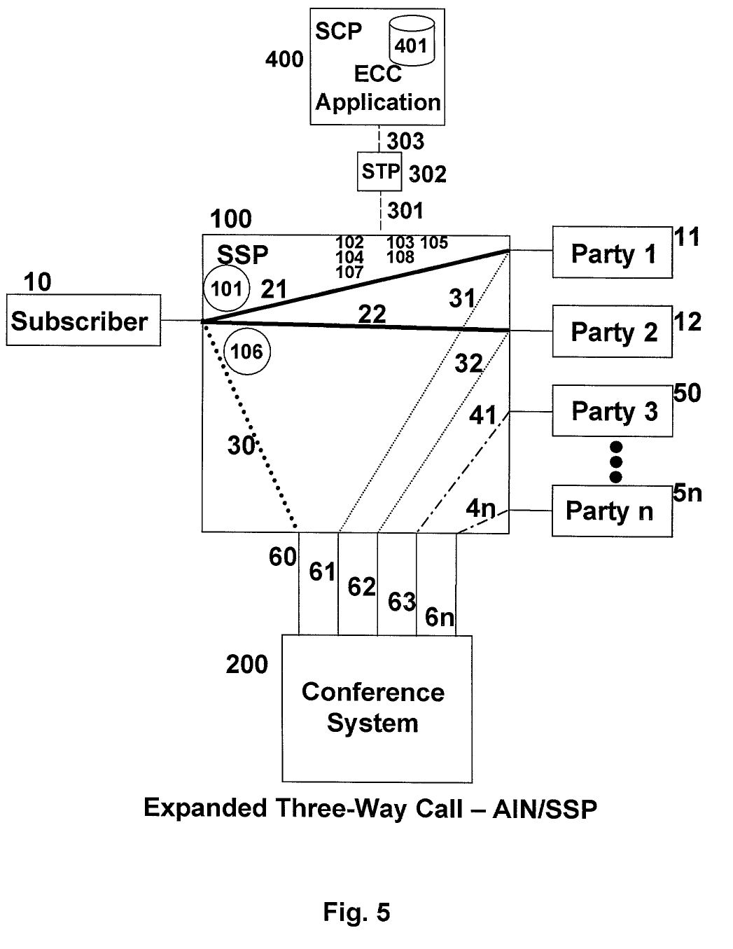

FIG. 5 schematically depicts the execution of the ECC system for active two party or Three-Way call via the Advanced Intelligent Network (AIN) architecture and a PSTN SSP end office;

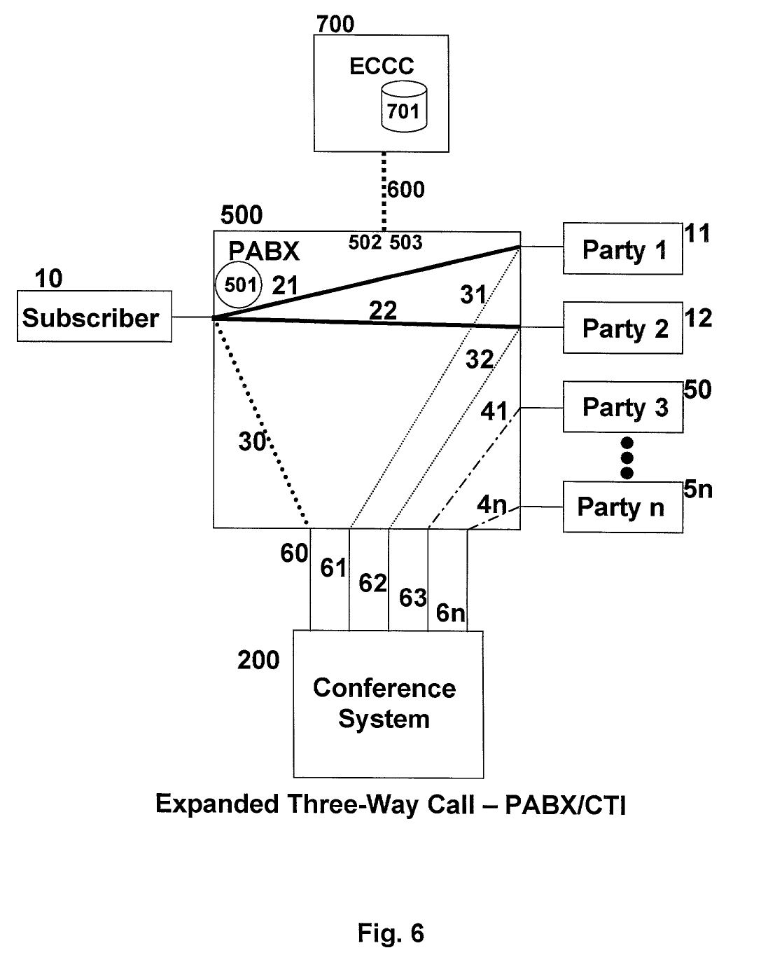

FIG. 6 schematically depicts the execution of the ECC system for active two party or Three-Way call via a PABX and Computer Telephony Interface (CTI) architecture;

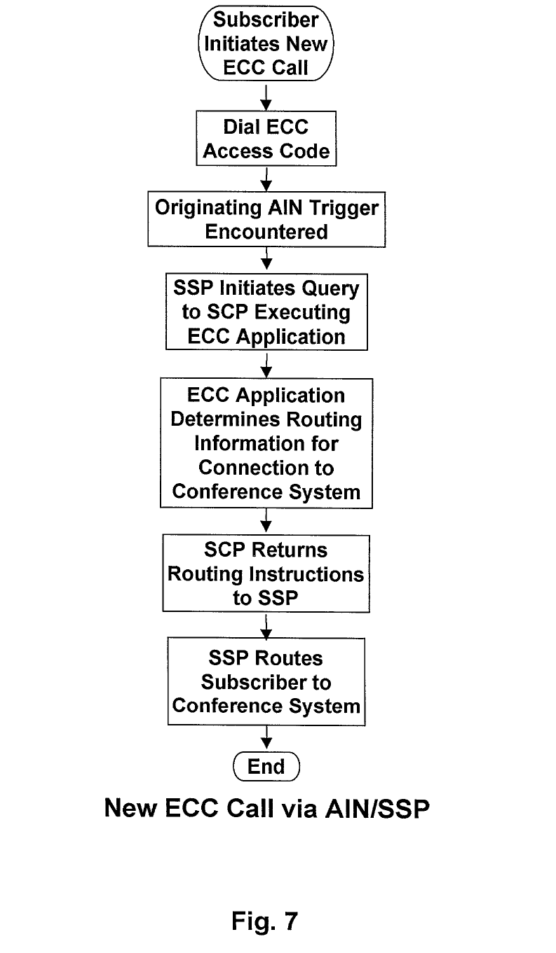

FIG. 7 schematically depicts a call flow for a new call to ECC System for a PSTN AIN/SSP subscriber;

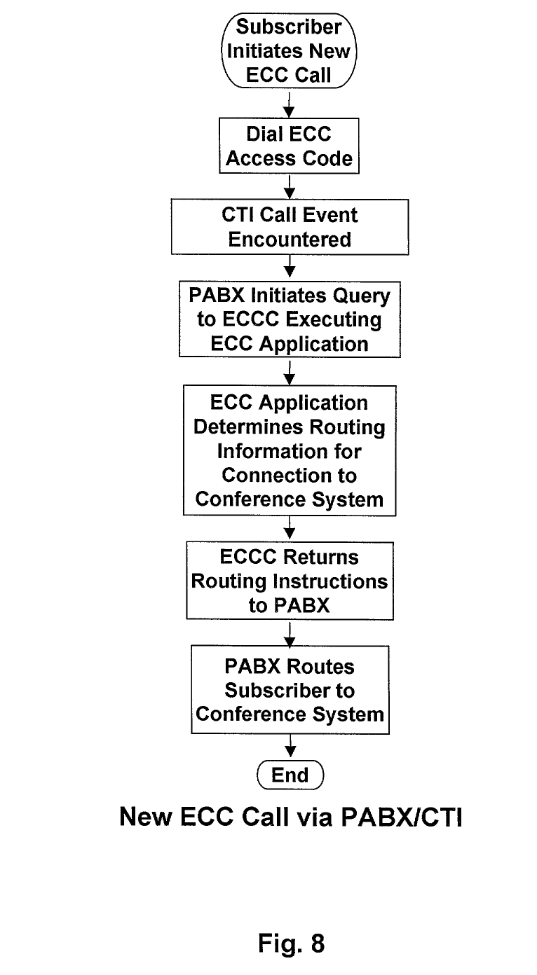

FIG. 8 schematically depicts a call flow for a new call to ECC System for a PABX/CTI subscriber;

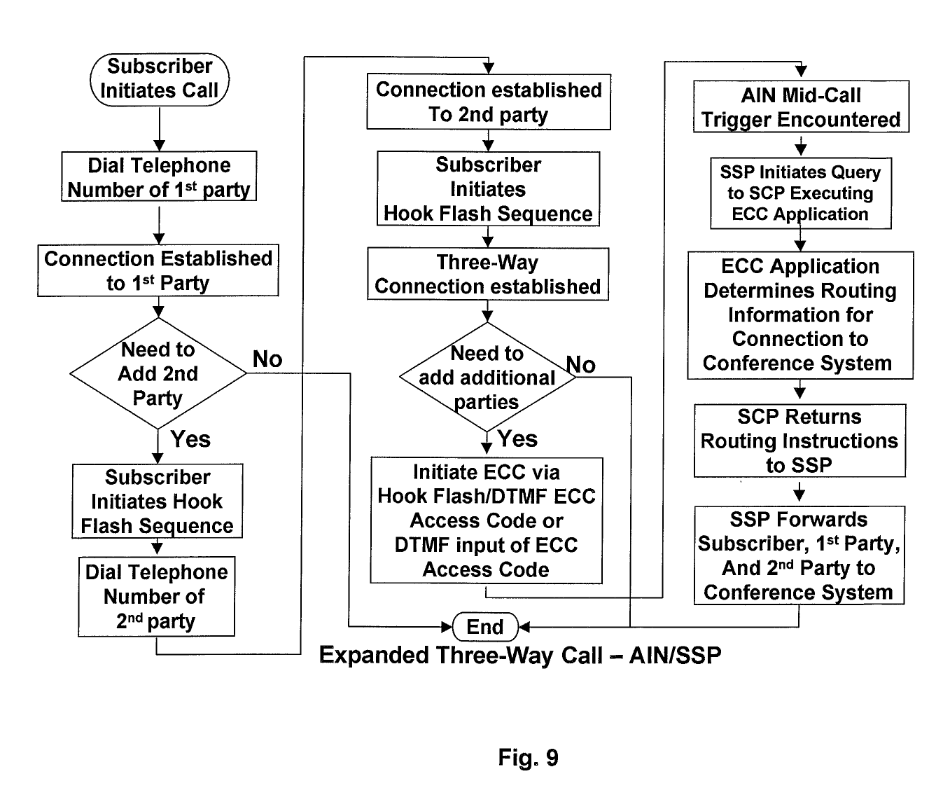

FIG. 9 schematically depicts a call flow for the ECC system for an active two party or Three-Way call via the Advanced Intelligent Network (AIN) architecture and a PSTN SSP end office; and

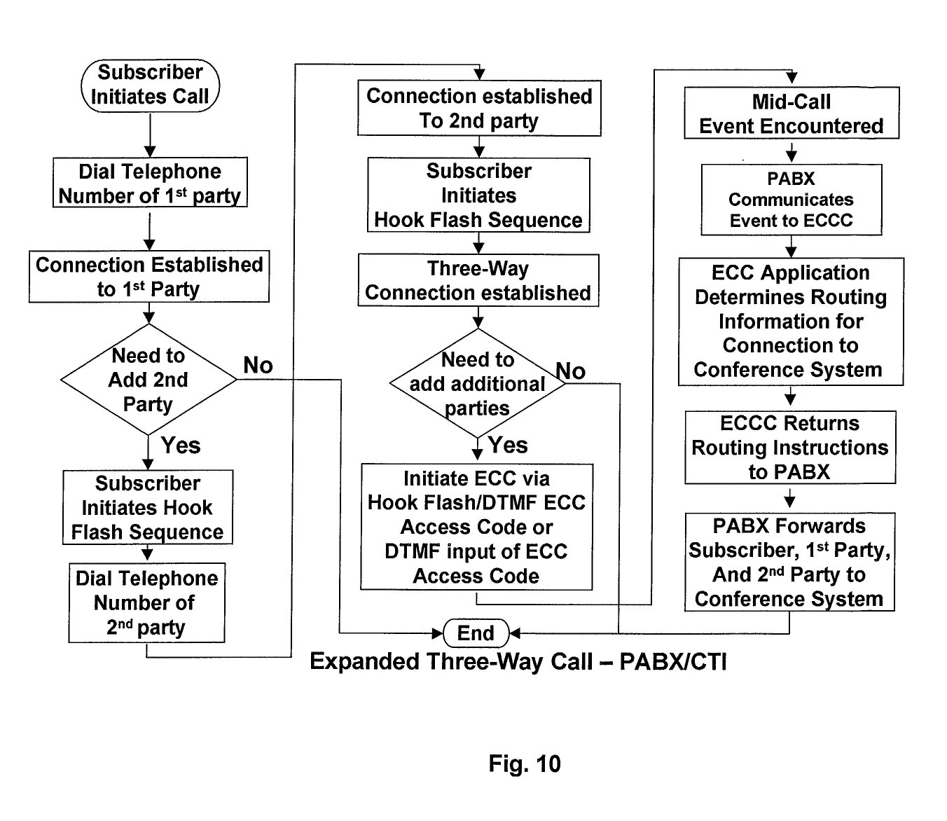

FIG. 10 schematically depicts a call flow for the ECC system for active two party or Three-Way call via a PABX and CTI architecture.

### ECC SYSTEM FOR A NEW CALL

Referring now to the drawings for this overview, FIG. 1 schematically depicts a subscriber initiating a new call to a Conference System by dialing an ECC Access Code. The “Subscriber” is the call participant that has the ability to initiate an ECC conference call. The “Serving Switch” can consist of either a Class 5 PSTN circuit switched End Office, a Class 5 PSTN SSP circuit switched End Office, a circuit switched PABX, a Hybrid circuit switched PABX/Key System, a circuit switched Mobile Switching Office (MSO), a packet switched Class 5 end office or equivalent controlled by “Softswitch” technologies, a packet switched PABX or Hybrid PABX/Key System controlled by “Softswitch” technologies, or a packet switched MSO controlled by “Softswitch” technologies. The “Conference System” is any conference system that supports on-demand conference calling via control of the conference Subscriber. The Conference System can be connected to the PSTN or to a PABX. The ECC “Subscriber” must be connected to the ECC serving switch. Other call participants could be connected to the same switch as the ECC subscriber or to other switching entities connected to the PSTN, e.g., PSTN end office, PABX, Hybrid PABX/Key system.

More specifically, Subscriber 10 served by Serving Switch 100 goes Off-Hook and dials the ECC Access Code. The Serving Switch 100 either encounters an internal ECC application or a call event trigger which communicates with the external ECC application.

The ECC application provides the Directory Number (DN) of the Conference System 200 port 60 to the Serving Switch 100. ECC execution is completed.

Serving Switch 100 establishes Connection 30 between Subscriber 10 and Conference System 200 port 60.

Conference call connections with other participants are controlled by the Subscriber 10 and Conference System 200. Connections 31, 32, 33, through 3n via Conference System 200 ports 61, 62, 63, through 6n are established.

The ECC application required to execute the above call procedures as defined in this invention can be integrated into internal call processing of the serving switch or provided by an external computing platform.

ECC System for Existing two Party or Three-Way Call

For this overview, FIG. 2 schematically depicts the physical switch connections described by this invention for existing participants of an active two party or Three-Way call. The “Subscriber” is the call participant that has the ability to initiate an ECC conference call. The “Serving Switch” can consist of either a Class 5 PSTN circuit switched End Office, a Class 5 PSTN SSP circuit switched End Office, a circuit switched PABX, a Hybrid circuit switched PABX/Key System, a circuit switched MSO, a packet switched Class 5 end office or equivalent controlled by “Softswitch” technologies, a packet switched PABX or Hybrid PABX/(Key System controlled by “Softswitch” tehnologies, or a packet switched MSO controlled by “Softwsitch” technologies. The “Conference System” is any conference system that supports adding additional participants via control of the conference Subscriber. The Conference System can be connected to the PSTN or to a PABX. The ECC “Subscriber” must be connected to the ECC serving switch. Other call participants could be connected to the same switch as the ECC subscriber or to other switching entities connected to the PSTN, e.g., PSTN end office, PABX, Hybrid PABX/Key system.

More specifically, Subscriber 10 served by Serving Switch 100 initiates a call to Party 11 by dialing Party 11 DN. When Party 11 answers the call, switch connection 21 is established in the serving switch 100. Subscriber 10 has a need to add a third party to the call. Subscriber 10 initiates a “Hook Flash”, receives dial tone, and dials Party 12 DN. Party 12 answers the call and switch connection 22 is established in the serving switch 100. Subscriber 10, Party 11, and Party 12 are bridged together by the internal Serving Switch 100 Three-Way conference bridge.

Subscriber 10 via the ECC system desires to add Party 50 to the established call. Subscriber 10 initiates ECC via the subscribed activation method. ECC activation can be via a “Hook Flash” followed by Dual Tone Multi-Frequency (DTMF) dialed digits, via direct DTFM digit dialing without a “Hook Flash”, or via alternative input method such as key borad entry or dial pad without DTMF. The dialed digits represent the ECC system Access Code. The ECC system will identify the “Conference System” that will provide the conference connection by providing the DN(s) associated with the Conference System 200 access ports 60, 61 and 62.

Subscriber 10 connections 21 and 22 to Party's 11 and 12 are disconnected, and connection 30 is established to the Conference System 200 Port 60. Connection 31 is established between Party 11 switch port and Conference System 200 Port 61. Connection 32 is established between Party 12 switch port and Conference System 200 Port 62.

Subscriber 10 initiates Conference System 200 procedures to add Party 50 to the Conference System 200 bridge Port 63 and connection 41 to Party 50. If Subscriber 10 desires to add additional parties to the call, Subscriber 10 continues with Conference System 200 procedures to add Parties up to Sn as determined by the Conference System 200 and associated connections 4n.

The ECC application required to execute the above call procedures as defined in this invention can be integrated into internal call processing of the serving switch or provided by an external computing platform.

External Platform Execution

The external computing platform could consist of an Advanced Intelligent Network (AIN) Service Control Point (SCP), a “Softswitch”, a Feature Server, or a standalone computing platform, Expanded Conference Call Controller (ECCC), executing the ECC application.

AIN/SSP—New ECC Call:

Referring to FIGS. 3 and 7 for this implementation, Subscriber 10 served by SSP 100 initiates a call to the ECC System by dialing the ECC Access Code. AIN Trigger 101 is encountered during call origination in SSP 100. SSP 100 launches an AIN Query message 102 containing Subscriber 10 call information including the ECC Access Code dialed. The AIN Query message 102 is transmitted via the SS7 signaling network consisting of SS7 Signaling Link 301, Signal Transfer Point (STP) 302, and SS7 Signaling Link 303 to the Service Control Point (SCP) 400 containing the ECC application for Subscriber 10. This invention uses normal SS7 message routing techniques.

SCP 400 retrieves account and AIN service records for Subscriber 10. Subscriber 10's record contains the ECC application 401. The ECC application 401 determines the Directory Number(s) of the Conference System that will handle Subscriber 10 ECC system requests. Although the detailed design of the ECC system application is outside the scope of this invention, multiple different solutions could be executed to determine the Directory Number of the Conference System to handle this call request. The solutions could range from pre-defined DN(s) with a fixed number of conference ports available to real time On-Demand methods and systems that allocate conference resources based upon the Subscriber's ECC activation requests and interactions with the Subscriber to establish conference port resource requirements.

SCP 400 returns AIN Response message 103 to SSP 100 with instructions to route the call to the DN associated with Conference System 200 Port 60.

SSP 100 receives AIN Response message 103 and establishes network Connection 30 to Conference System 200 based on the DN returned from ECC Application 401.

Connections 31, 32, 33, through 3n with participants 11, 12, 50, through 5n are controlled by the Subscriber 10 and Conference System 200.

PABX—New ECC Call:

Referring to FIGS. 4 and 8 for this implementation, Subscriber 10 served by PABX 500 initiates a call to the ECC System by dialing the ECC Access Code. CTI call processing event 501 is encountered during call origination in PABX 500. PABX 500 launches query message 502 containing Subscriber 10 call information including the ECC Access Code dialed. Communication path 600 between the PABX 500 and ECCC platform 700 can consist of various OSI layer 1-3 technologies. ECC application 701 contained in ECCC platform 700 is executed.

ECC application 701 retrieves call context and service record information for Subscriber 10. The ECC application 701 determines the Directory Number(s) of the Conference System that will handle Subscriber 10 ECC system requests. Although the detailed design of the ECC system application is outside the scope of this invention, multiple different solutions could be executed to determine the Directory Number of the Conference System to handle this call request. The solutions could range from predefined DN(s) with a fixed number of conference ports available to real time On-Demand methods and systems that allocate conference resources based upon the Subscriber's ECC activation requests and interactions with the Subscriber to establish conference port resource requirements.

ECCC 700 returns Response message 503 via Communications path 600 to PABX 500 with instructions to route the call to the DN associated with Conference System 200 Port 60.

PABX 500 receives Response message 503 and establishes network Connection 30 to Conference System 200 based on the DN returned from ECC Application 401.

Connections 31, 32, 33, through 3n with participants 11, 12, 50, through 5n are controlled by the Subscriber 10 and Conference System 200.

ECC System for Existing two Party or Three-Way Call—AIN/SSP:

Referring to FIGS. 5 and 9 for this implementation, Subscriber 10 originates a call to Party 11 by dialing Party 11 DN. AIN Trigger 101 is encountered during call origination in SSP 100. SSP 100 launches an AIN Query message 102 containing Subscriber 10 call information including Party 11 directory number. The AIN Query message 102 is transmitted via the SS7 signaling network consisting of SS7 Signaling Link 301, STP 302, and SS7 Signaling Link 303 to the SCP 400 containing the ECC application 401 for Subscriber 10. This invention uses normal SS7 message routing techniques.

SCP 400 retrieves account and AIN service records for Subscriber 10. Subscriber 10 record contains the ECC application 401. The ECC application 401 returns a Response message 103 to SSP 100 with instructions to set Mid-Call trigger 106 and continue call processing to Party 11 directory number.

SSP 100 establishes connection 21 to Party 11 and activates Mid-Call trigger 106.

Subscriber 10 initiates a “Hook Flash” and dials Party 12 DN. AIN Trigger 101 is encountered during call processing by SSP 100. SSP 100 launches AIN Query message 104 containing Subscriber 10 call information including Party 12 DN. The AIN Query message 104 is transmitted via the SS7 signaling network consisting of SS7 Signaling Link 301, STP 302, and SS7 Signaling Link 303 to the SCP 400 containing the ECC application 401 for Subscriber 10.

SCP 400 retrieves call context and service record information for Subscriber 10. Subscriber's 10 service record contains call context information for the call leg connection to Party 11. The ECC application 401 returns a Response message 105 to SSP 100 with instructions to maintain Mid-Call trigger 106 and continue call processing to Party 12 directory number.

SSP 100 establishes connection 22 to Party 12, maintains Mid-Call trigger 106, and completes the Three-Way call.

Subscriber 10 initiates ECC call procedures by dialing via DTMF the access code for the ECC system; i.e., dials *11. SSP 100 AIN Mid-Call Trigger 106 is encountered upon receipt of the DTMF digit string. AIN Query message 107 containing Subscriber 10 call information is transmitted to the SCP 400 containing Subscriber 10 ECC application 401. The AIN Query message 107 is transmitted via the SS7 signaling network consisting of SS7 Signaling Link 301, STP 302, and SS7 Signaling Link 303 to SCP 400.

SCP 400 retrieves call context and service record information for Subscriber 10. The ECC application 401 in SCP 400 determines the Directory Number(s) of the Conference System that will handle Subscriber 10 ECC system requests. Although the detailed design of the ECC system application is outside the scope of this invention, multiple different solutions could be executed to determine the Directory Number of the Conference System to handle this call request. The solutions could range from predefined DN(s) with a fixed number of conference ports available to real time On-Demand methods and systems that allocate conference resources based upon the Subscriber's ECC activation requests and interactions with the Subscriber to establish conference port resource requirements.

If required, SCP 400 ECC application 401 may request additional call context information from SSP 100 in order to complete call routing instructions.

SCP 400 will return AIN Response message 108 containing “Leg Manipulation” and Conference System DN(s) routing instructions. SCP 400 ECC application 401 will also determine Automatic Message Accounting (AMA) requirements necessary to support the ECC system and communicate with SSP 100 as appropriate.

SSP 100 will manipulate the existing call legs by deleting connections 21 and 22 and establishing call leg connections 30, 31, and 32. Connections 30, 31, and 32 will be routed to the DN(s) assigned to the Conference System ports 60, 61, and 62. Conference System ports 60, 61, and 62 can be terminated on the SSP 100, another PSTN switch, or a PABX.

ECC System for Existing two Party or Three-Way Call—PABX/CTI:

The type(s) of external call control methods available will be dependent upon the PABX technology. For this invention, these interfaces/technologies will be generically called Computer Telephony Interfaces (CTI). These interfaces are also known as Switch to Computer Applications Interface (SCAI), Parlay, or Java APIs for Integrated Networks (JAIN). Exact call processing/handling procedures necessary to execute ECC System via a PABX will vary with each interface and PABX technology.

Referring to FIGS. 6 and 10 for this implementation, Subscriber 10 originates a call to Party 11 by dialing Party 11 DN. Because the Subscriber in this instance is served by a PABX 500, Party 11 DN dialed can be an Intercom number containing 1 to 7 digits. Party 11 DN would be a PSTN 7 or 10 digit number if located in the PSTN. CTI call processing events in PABX 500 are depicted by Event 501. Multiple events may be required to execute the ECC system. Messages communicated between PABX 500 and ECCC platform 700 are depicted by messages 502 and 503. Multiple messages may be required to execute the ECC system. Communication path 600 between the PABX 500 and ECCC platform 700 can consist of various OSI layer 1-3 technologies. ECC application 701 contained in ECCC platform 700 is executed.

PABX 500 establishes connection 21 to Party 11.

Subscriber 10 initiates a “Hook Flash” and dials Party 12 DN. Appropriate call processing events 501 and message communications 502 and 503 between PABX 500 and ECCC platform 700 are executed. ECC application 701 contained in ECCC platform 700 is executed.

PABX 500 establishes connection 22 to Party 12. An active Three-Way call is now established between the Subscriber, Party 11, and Party 12.

Subscriber 10 initiates ECC call procedures by either Hook Flash followed by dialing via DTMF the access code for the ECC system; i.e., dials * 11 or direct input of a DTMF digit string for the access code. PABX 500 Event 501 is encountered and query message 502 containing Subscriber 10 call context information is transmitted to the ECCC platform 700 via communication path 600.

ECC application 701 retrieves call context and service record information for Subscriber 10. The ECC application 701 determines the Directory Number(s) of the Conference System that will handle Subscriber 10 ECC system requests. Although the detailed design of the ECC system application is outside the scope of this invention, multiple different solutions could be executed to determine the Directory Number of the Conference System to handle this call request. The solutions could range from predefined DN(s) with a fixed number of conference ports available to real time On-Demand methods and systems that allocate conference resources based upon the Subscriber's ECC activation requests and interactions with the Subscriber to establish conference port resource requirements.

If required, ECC application 701 may request additional call context information from PABX 500 in order to complete call routing instructions.

ECC application 701 will return Response message 503 containing “Leg Manipulation” and Conference System DN(s) routing instructions as appropriate for the specific CTI interface.

PABX 500 will manipulate the existing call legs by deleting connections 21 and 22 and establishing call leg connections 30, 31, and 32. Connections 30, 31, and 32 will be routed to the DN(s) assigned to the Conference System ports 60, 61, and 62. These DN(s) can be assigned to the PABX 500 or routed to PSTN DN(s) via the PABX 500 CO Trunks.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

Now that the invention has been described,

What is claimed is:

1. A system for a subscriber to establish an on-demand conference call in a telecommunications network including a plurality of switching systems, one or more of which having one or more conference bridges, the system comprising:
means for dialing and assigning an ECC Access Code which is common for all ECC subscribers served by a plurality of switches; and
the ECC Access Code being conference call initiation means comprising a dialing sequence of less than seven digits.

2. The system according to claim 1, wherein the dialing sequence includes any one of a Vertical Service Code format consisting of *XX where X is any digit 0 to 9, an abbreviated dialing sequence of *XXX, * XXXX, or *XXXXXX where X is any digit 0 to 9, an abbreviated dialing sequence of #XX, #XXX, #XXXX, #XXXXX, or #XXXXXX where X is any digit 0 to 9, an abbreviated dialing sequence of XX*, XXX*, XXXX*, XXXX , or XXXXX* where X is any digit 0 to 9, and an abbreviated dialing sequence of XX#, XXX#, XXXX#, XXXXX#, or X where X is any digit 0 to 9.

3. The system according to claim 1, further comprising:
means for initiating the on-demand conference call by going Off-Hook and dialing the ECC Access Code; and
wherein the subscriber initiating the on-demand conference call is not connected to a party participant.

4. The system according to claim 1, further comprising:
means for connecting active call participants in an established two party or three-way call to a conference system without having to disconnect the active parties;
means for the subscriber to initiate the ECC activation sequence by one of a Hook Flash followed by dialing via Dual Tone Multi-Frequency (DTMF) the ECC Access Code, via dialing the ECC Access Code via DTMF without the Hook-Flash, and via other input methods including key board entry without DTMF and dial pad without DTMF;
means for a serving switch to recognize the ECC Access Code and to execute steps to transfer the active call participants to the conference system, the serving switch comprising one of a circuit switched Class 5 PTSN end office, a circuit switched Class 5 PTSN SSP end office, a circuit switched PABX, a HYBRID circuit switched PABX/Key system, a circuit switched Mobile Switching Office (MSO), a packet switched Class 5 end office or equivalent controlled by “Softswitch” technologies, a packet switched PABX or Hybrid PABX/Key System controlled by “Softswitch” technologies, or a packet switched MSO controlled by “Softswitch” technologies; and
means for the serving switch to route the established call participants to the conference system based upon destination information provided by an ECC application.

5. The system according to claim 3, wherein an ECC application for the initiation of a new conference call to a Conference System is performed through one of internally in a serving switch embedded operations program and externally to the serving switch.

6. The system according to claim 4, wherein the ECC application for transferring of active call participants to the Conference System is performed through one of internally in a serving switch embedded operations program and externally to the serving switch.

7. The system according to claim 6, wherein communications between the serving switch and the external ECC application can utilize communications procedures supported by serving switching technology comprising one of Advanced Intelligent Network (AIN) Service Control Point (SCP) to Service Switching Point (SSP) procedures, Computer Telephony Interfaces (CTI), Switch to Computer Applications Interface (SCAI), Parlay, Java APIs for Integrated Networks (JAIN), and other defined switch to external interfaces.

8. The system according to claim 3, further comprising:
means for identifying the subscriber; and
means for maintaining an account record and profile related to the subscriber, including Conference System routing information,
wherein upon identification of the subscriber, the system accesses the subscriber's account record and profile to obtain the Conference System routing information.

9. The system according to claim 4, further comprising:
means for identifying the subscriber; and
means for maintaining an account record and profile related to the subscriber, including Conference System routing information,
wherein upon identification of the subscriber, the system accesses the subscriber's account record and profile to obtain the Conference System routing information.

10. The system according to claim 4, further comprising:
means for enabling communication procedures including Advanced Intelligent Network (AIN) Originating triggers, call processing procedures and CTI call initiation procedures during the initiation of the established two party and three-way calls.

11. The system according to claim 7, further comprising:
means for the ECC application to initiate additional information requests to the serving switch; and
means for the ECC application to return call routing instructions to the serving switch to connect the existing parties to the Conference System.

12. The system according to claim 7, wherein communications between the serving switch and an external computing platform containing the ECC application can utilize a plurality of Open Systems Interconnection (OSI) layer 1-3 technologies, including SS7, digital data circuit, analog modem, Internet Protocol (IP) and LAN/WAN.

13. A system for a subscriber to establish an on-demand conference call in a telecommunications network including a plurality of switching systems, one or more of which having one or more conference bridges, the system comprising:
means for dialing and assigning an ECC Access Code which is common for all ECC subscribers served by a plurality of switches; and
the ECC Access Code being conference call initiation means comprising a dialing sequence of less than seven digits,
wherein the dialing sequence includes any one of a Vertical Service Code format consisting of *XX where X is any digit 0 to 9, an abbreviated dialing sequence of *XXX, *XXXX, *XXXXX, or *XXXXXX where X is any digit 0 to 9, an abbreviated dialing sequence of #XX, #XXX, #XXXX, #XXXXX, or #XXXXXX where X is any digit 0 to 9, an abbreviated dialing sequence of XX*, XXX*, XXXX*, XXXXX*, or XXXXXX* where X is any digit 0 to 9, and an abbreviated dialing sequence of XX#, XXX#, XXXX#, XXXXX#, or XXXXXX# where X is any digit 0 to 9.

14. The system according to claim 13, further comprising:
means for initiating the on-demand conference call by going Off-Hook and dialing the ECC Access Code; and
wherein the subscriber initiating the on-demand conference call is not connected to a party participant.

15. The system according to claim 13, further comprising:
means for connecting active call participants in an established two party or three-way call to a conference system without having to disconnect the active parties;
means for the subscriber to initiate the ECC activation sequence by one of a Hook Flash followed by dialing via Dual Tone Multi-Frequency (DTMF) the ECC Access Code, via dialing the ECC Access Code via DTMF without the Hook-Flash and via other input methods including key board entry without DTMF and dial pad without DTMF;
means for a serving switch to recognize the ECC Access Code and to execute steps to transfer the active call participants to the conference system, the serving switch comprising one of a circuit switched Class 5 PTSN end office, a circuit switched Class 5 PTSN SSP end office, a circuit switched PABX, a HYBRID circuit switched PABX/Key system, a circuit switched Mobile Switching Office (MSO), a packet switched Class 5 end office or equivalent controlled by “Softswitch” technologies, a packet switched PABX or Hybrid PABX/Key System controlled by “Softswitch” technologies, or a packet switched MSO controlled by “Softswitch” technologies; and
means for the serving switch to route the established call participants to the conference system based upon destination information provided by an ECC application.

16. The system according to claim 14, wherein an ECC application for the initiation of a new conference call to a Conference System is performed through one of internally in a serving switch embedded operations program and externally to the serving switch.

17. The system according to claim 15, wherein the ECC application for transferring of active call participants to the Conference System is performed through one of internally in a serving switch embedded operations program and externally to the serving switch.

18. The system according to claim 17, wherein communications between the serving switch and the external ECC application can utilize communications procedures supported by serving switching technology comprising one of Advanced Intelligent Network (AIN) Service Control Point (SCP) to Service Switching Point (SSP) procedures, Computer Telephony Interfaces (CTI), Switch to Computer Applications Interface (SCAI), Parlay, Java APIs for Integrated Networks (JAIN), and other defined switch to external interfaces.

19. The system according to claim 14, further comprising:
means for identifying the subscriber; and
means for maintaining an account record and profile related to the subscriber, including Conference System routing information,
wherein upon identification of the subscriber, the system accesses the subscriber's account record and profile to obtain the Conference System routing information.

20. The system according to claim 15, further comprising:
means for identifying the subscriber; and
means for maintaining an account record and profile related to the subscriber, including Conference System routing information,
wherein upon identification of the subscriber, the system accesses the subscriber's account record and profile to obtain the Conference System routing information.

21. The system according to claim 15, further comprising:
means for enabling communication procedures including Advanced Intelligent Network (AIN) Originating triggers, call processing procedures and CTI call initiation procedures during the initiation of the established two party and three-way calls.

22. The system according to claim 18, further comprising:
means for the ECC application to initiate additional information requests to the serving switch; and
means for the ECC application to return call routing instructions to the serving switch to connect the existing parties to the Conference System.

23. The system according to claim 18, wherein communications between the serving switch and an external computing platform containing the ECC application can utilize a plurality of Open Systems Interconnection (OSI) layer 1-3 technologies, including SS7, digital data circuit, analog modem, Internet Protocol (IP) and LAN/WAN.

24. A method for a subscriber to establish an on-demand conference call in a telecommunications network including a plurality of switching systems, one or more of which having one or more conference bridges, the method comprising:
providing means for dialing and assigning an ECC Access Code which is common for all ECC subscribers served by a plurality of switches; and
dialing said subscriber ECC Access Code, wherein the ECC Access Code is the conference call initiation means comprising a dialing sequence of less than seven digits.

25. The method according to claim 24, wherein the dialing sequence includes any one of a Vertical Service Code format consisting of *XX where X is any digit 0 to 9, an abbreviated dialing sequence of *XXX, *XXXX, *XXXXX, or *XXXXXX where X is any digit 0 to 9, an abbreviated dialing sequence of #XX, #XXX, #XXXX, #XXXXX, or #XXXXXX where X is any digit 0 to 9, an abbreviated dialing sequence of XX*, XXX*, XXXX*, XXXXX*, or XXXX * where X is any digit 0 to 9, and an abbreviated dialing sequence of XX#, XXX#, XXX X #, or XXX# where X is any digit 0 to 9.

26. The method according to claim 24, further comprising:
providing means for initiating the on-demand conference call by going Off-Hook and dialing the ECC Access Code; and
initiating the on-demand conference call by going Off-Hook and dialing the ECC Access Code,
wherein the subscriber initiating the on-demand conference call is not connected to a party participant.

27. The method according to claim 24, further comprising:
providing means for connecting active call participants in an established two party or three-way call to a conference system without having to disconnect the active parties;
providing means for the subscriber to initiate the ECC activation sequence by one of a Hook Flash followed by dialing via Dual Tone Multi-Frequency (DTMF) the ECC Access Code, via dialing the ECC Access Code via DTMF without the Hook-Flash and via other input methods such as key board entry without DTMF and dial pad without DTMF;
providing means for a serving switch to recognize the ECC Access Code and to execute steps to transfer the active call participants to the conference system, the serving switch comprising one of a circuit switched Class 5 PTSN end office, a circuit switched Class 5 PTSN SSP end office, a circuit switched PABX, a HYBRID circuit switched PABX/Key system, a circuit switched Mobile Switching Office (MSO), a packet switched Class 5 end office or equivalent controlled by “Siftswitch” technologies, a packet switched PABX or Hybrid PABX/Key System controlled by “Softswitch” technologies, or a packet switched MSO controlled by “Softswitch” technologies;
providing means for the serving switch to route the established call participants to the conference system based upon destination information provided by an ECC application; and
connecting the active call participants in the established two party or three-way call to the conference system without disconnecting the active parties,
wherein the subscriber initiates the ECC activation sequence by one of a Hook Flash followed by dialing via Dual Tone Multi-Frequency (DTMF) the ECC Access Code, via dialing the ECC Access Code via DTMF without the Hook-Flash and via the other input methods including key board entry without DTMF and dial pad without DTMF,
wherein the serving switch recognizes the ECC Access Code and executes steps to transfer the active call participants to the conference system, and
wherein the serving switch then routes the established call participants to the conference system based upon destination information provided by an ECC application.

28. The method according to claim 26, wherein an ECC application for the initiation of a new conference call to a Conference System is performed through one of internally in a serving switch embedded operations program and externally to the serving switch.

29. The method according to claim 27, wherein the ECC application for transferring of active call participants to the Conference System is performed through one of internally in a serving switch embedded operations program and externally to the serving switch.

30. The method according to claim 29, wherein communications between the serving switch and the external ECC application can utilize communications procedures supported by serving switching technology comprising one of Advanced Intelligent Network (AIN) Service Control Point (SCP) to Service Switching Point (SSP) procedures, Computer Telephony Interfaces (CTI), Switch to Computer Applications Interface (SCAI), Parlay, Java APIs for Integrated Networks (JAIN), and other defined switch to external interfaces.

31. The method according to claim 26, further comprising:
providing means for identifying the subscriber; and
providing means for maintaining an account record and profile related to the subscriber, including Conference System routing information,
wherein upon identification of the subscriber, the system accesses the subscriber's account record and profile to obtain the Conference System routing information.

32. The method according to claim 27, further comprising:
providing means for identifying the subscriber; and
providing means for maintaining an account record and profile related to the subscriber, including Conference System routing information,
wherein upon identification of the subscriber, the system accesses the subscriber's account record and profile to obtain the Conference System routing information.

33. The method according to claim 27, further comprising:
providing means for enabling communication procedures including Advanced Intelligent Network (AIN) Originating triggers, call processing procedures and CTI call initiation procedures during the initiation of the established two party and three-way calls.

34. The method according to claim 30, further comprising:
providing means for the ECC application to initiate additional information requests to the serving switch; and
providing means for the ECC application to return call routing instructions to the serving switch to connect the existing parties to the Conference System.

35. The method according to claim 30, wherein communications between the serving switch and an external computing platform containing the ECC application can utilize a plurality of Open Systems Interconnection (OSI) layer 1-3 technologies, including SS7, digital data circuit, analog modem, Internet Protocol (IP) and LAN/WAN.

36. A method for a subscriber to establish an on-demand conference call in a telecommunications network including a plurality of switching systems, one or more of which having one or more conference bridges, the method comprising:
providing means for dialing and assigning an ECC Access Code which is common for all ECC subscribers served by a plurality of switches; and
dialing said subscriber ECC Access Code,
wherein the ECC Access Code is the conference call initiation means comprising a dialing sequence of less than seven digits, and
wherein the dialing sequence includes any one of a Vertical Service Code format consisting of *XX where X is any digit 0 to 9, an abbreviated dialing sequence of *XXX, *XXXX, *XXXXX, or *XXXXXX where X is any digit 0 to 9, an abbreviated dialing sequence of #XX, #XXX, #XXXX, #XXXXX, or #XXXXXX where X is any digit 0 to 9, an abbreviated dialing sequence of XX*, XXX*, XX*, XXXXX*, or XXXXXX* where X is any digit 0 to 9, and an abbreviated dialing sequence of XX#, XXX#, XXXX#, XX#, or XXXXXX# where X is any digit 0 to 9.

37. The method according to claim 36, further comprising:
providing means for initiating the on-demand conference call by going Off-Hook and dialing the ECC Access Code; and
initiating the on-demand conference call by going Off-Hook and dialing the ECC Access Code,
wherein the subscriber initiating the on-demand conference call is not connected to a party participant.

38. The method according to claim 36, further comprising:
providing means for connecting active call participants in an established two party or three-way call to a conference system without having to disconnect the active parties;
providing means for the subscriber to initiate the ECC activation sequence by one of a Hook Flash followed by dialing via Dual Tone Multi-Frequency (DTMF) the ECC Access Code, via dialing the ECC Access Code via DTMF without the Hook-Flash and via other input methods including key board entry without DTMF and dial pad without DTMF;
providing means for a serving switch to recognize the ECC Access Code and to execute steps to transfer the active call participants to the conference system, the serving switch comprising one of a circuit switched Class 5 PTSN end office, a circuit switched Class 5 PTSN SSP end office, a circuit switched PABX, a HYBRID circuit switched PABX/Key system, a circuit switched Mobile Switching Office (MSO), a packet switched Class 5 end office or equivalent controlled by “Softswitch” technologies, a packet switched PABX or Hybrid PABX/Key System controlled by “Softswitch” technologies, or a packet switched MSO controlled by “Softswitch” technologies;
providing means for the serving switch to route the established call participants to the conference system based upon destination information provided by an ECC application; and
connecting the active call participants in the established two party or three-way call to the conference system without disconnecting the active parties,
wherein the subscriber initiates the ECC activation sequence by one of a Hook Flash followed by dialing via Dual Tone Multi-Frequency (DTMF) the ECC Access Code, via dialing the ECC Access Code via DTMF without the Hook-Flash and via other input methods including key board entry without DTMF and dial pad without DTMF,
wherein the serving switch recognizes the ECC Access Code and executes steps to transfer the active call participants to the conference system, and
wherein the serving switch then routes the established call participants to the conference system based upon destination information provided by an ECC application.

39. The method according to claim 37, wherein an ECC application for the initiation of a new conference call to a Conference System is performed through one of internally in a serving switch embedded operations program and externally to the serving switch.

40. The method according to claim 38, wherein the ECC application for transferring of active call participants to the Conference System is performed through one of internally in a serving switch embedded operations program and externally to the serving switch.

41. The method according to claim 40, wherein communications between the serving switch and the external ECC application will utilize communications procedures supported by serving switching technology comprising one of Advanced Intelligent Network (AIN) Service Control Point (SCP) to Service Switching Point (SSP) procedures, Computer Telephony Interfaces (CTI), Switch to Computer Applications Interface (SCAI), Parlay, Java APIs for Integrated Networks (JAIN), and other defined switch to external interfaces.

42. The method according to claim 37, further comprising:
providing means for identifying the subscriber; and
providing means for maintaining an account record and profile related to the subscriber, including Conference System routing information,
wherein upon identification of the subscriber, the system accesses the subscriber's account record and profile to obtain the Conference System routing information.

43. The method according to claim 38, further comprising:
providing means for identifying the subscriber; and
providing means for maintaining an account record and profile related to the subscriber, including Conference System routing information,
wherein upon identification of the subscriber, the system accesses the subscriber's account record and profile to obtain the Conference System routing information.

44. The method according to claim 38, further comprising:
providing means for enabling communication procedures including Advanced Intelligent Network (AIN) Originating triggers, call processing procedures and CTI call initiation procedures during the initiation of the established two party and three-way calls.

45. The method according to claim 41, further comprising:
providing means for the ECC application to initiate additional information requests to the serving switch; and
providing means for the ECC application to return call routing instructions to the serving switch to connect the existing parties to the Conference System.

46. The method according to claim 41, wherein communications between the serving switch and an external computing platform containing the ECC application can utilize a plurality of Open Systems Interconnection (OSI) layer 1-3 technologies, including SS7, digital data circuit, analog modem, Internet Protocol (IP) and LAN/WAN.
